(19) United States
(12) Patent Application Publication
(10) Pub. No.: US 2016/0323340 A1
(43) Pub. Date: Nov. 3, 2016

(54) SYSTEM AND METHOD FOR CONTROLLED REAL-TIME MEDIA STREAMING FROM A USER DEVICE

(71) Applicant: Reporty Homeland Security LTD., Tel-Aviv (IL)

(72) Inventor: Amir ELICHAI, Tel Aviv (IL)

(73) Assignee: Reporty Homeland Security LTD., Tel-Aviv (IL)

(21) Appl. No.: 15/206,735

(22) Filed: Jul. 11, 2016

Related U.S. Application Data
(63) Continuation of application No. PCT/IL2015/050051, filed on Jan. 15, 2015.
(60) Provisional application No. 61/928,027, filed on Jan. 16, 2014.

(51) Int. Cl. H04L 29/06; H04W 12/08; H04L 29/08

(52) U.S. Cl. CPC H04L 65/601; H04L 67/34; H04W 12/08

(57) ABSTRACT

A server is configured to control access of media streaming from one or more user devices to one or more content receivers. The user devices are registered by the server to be able to stream media content to certain of the content receivers. Then, when such media is to be streamed from an authorized user device to the one or more content receivers, the server determines eligibility to stream such content and performs the necessary control functions to enable such transfer. The server may allow, disconnect or disallow any user device attempting to stream media to anyone of the content receivers based on a variety of programmable rules.

### CROSS REFERENCE TO RELATED APPLICATIONS

This application is a continuation of International Application No. PCT/IL2015/050051 filed on Jan. 15, 2015 which claims the benefit of U.S. provisional patent application No. 61/928,027, filed on Jan. 16, 2014. The contents of the above-referenced application is incorporated herein by reference.

### TECHNICAL FIELD

The disclosure relates generally to media streaming and more particularly to controlled media streaming from a user device capable of capturing and streaming media to one or more content receivers. Even more particularly, the media streaming is real-time media streaming.

### BACKGROUND

Most of the mobile devices, smartphones, tables, notebook computers, and the like, sold today, are equipped with built-in different media capturing devices. As a result, events are recorded in different methods and distributed worldwide in an ever growing number. In fact, various bodies, such as the media and the police, make use of those clips provided by users of such mobile devices, may it be to inform the public through broadcast media of the folding of events in real-time, or, identifying a crime case as it occurs.

Currently the process of a user using such a mobile device to provide the media (video, audio, images, data, etc.) or the police with such information is not straightforward. In some cases, users simply upload the media content to social networks, such as Facebook®, YouTube® or Instagram®, and therefrom it finds its way to the police or the broadcasting networks. In some cases, this is done by contacting the desired consumer of the media content and uploading in one of a variety of mechanisms the content to that consumer. While a reasonable, though sub-optimal, solution in certain cases, it is not of value in cases where the content in valuable if transmitted in real-time.

In certain security systems, such as discussed, for example, in U.S. patent application Ser. No. 13/004,705 by Reitnour and Ser. No. 13/604,372 by Reitnour et al. a notification and tracking system for a mobile device is described which may further be used for emergency purposes. However, these proposed systems are deficient in various ways with respect to a developing emergency where a large number of callers attempt to report an emergency, deliver media content, or otherwise attempt various types of communication with, for example, a 911 emergency service.

Therefore, in view of the deficiencies of the prior art solutions to allow easy connectivity for media streaming from a user device to a content consumer, it would be advantageous to provide a solution that overcomes these deficiencies.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments disclosed herein include a method for controlled streaming of real-time media content. The method comprises receiving a request for a user device to stream the real-time media content to an at least one content receiver; determining, by an authorization server, whether the user device is authorized to send the real-time media content to at least one of the at least one content receiver; notifying, by the authorization server, the at least one of the at least one content receiver to accept the real-time media content from the user device responsive of affirmative determination made by the authorization server to permit the streaming of the media content to the at least one of the at least one content receiver; and notifying, by the authorization server, the user device to begin real-time media content streaming to the at least one of the at least one content receiver responsive of affirmative determination made by the authorization server to permit the streaming of the real-time media content to the at least one of the at least one content receiver.

Certain embodiments disclosed herein include a system for controlled streaming of real-time video content. The system comprises a network interface configured to communicatively connect to the at least a user device and to at least a content receiver, the user device is configured to stream in real-time media content captured by the user device; a processing element connected to the network interface; and a memory connected to the processing element, the memory containing instructions that when executed by the processing element, configure the system to: receive a request for a user device to stream the real-time media content to an at least one content receiver; determine whether the user device is authorized to send the real-time media content to at least one of the at least one content receiver; notify the at least one of the at least one content receiver to accept the real-time media content from the user device responsive of affirmative determination to permit the streaming of the media content to the at least one of the at least one content receiver; and notify the user device to begin real-time media content streaming to the at least one of the at least one content receiver responsive of affirmative determination made by the authorization server to permit the streaming of the real-time media content to the at least one of the at least one content receiver.

Certain embodiments disclosed herein include a mobile device mobile device for controlled streaming of real-time media content. The mobile device comprises a network interface configured to enable at least data communication to and from the mobile device; a processing element connected to the network interface; an image capturing device connected to the processing element and configured to capture of a real-time media stream; a memory connected to the processing element, the memory containing instructions that when executed by the processing element, configure the mobile device to: request authorization to provide a real-time video stream from the user device to at least a content receiver, the at least content receiver communicatively connected to the network; receive an authorization to stream to the at least a content receiver communicatively coupled to the network from the authorization server; and stream the real-time video stream to the at least content receiver.

### BRIEF DESCRIPTION OF THE DRAWINGS

The subject matter disclosed herein is particularly pointed out and distinctly claimed in the claims at the conclusion of the specification. The foregoing and other objects, features and advantages of the invention will be apparent from the following detailed description taken in conjunction with the accompanying drawings.

FIG. 1 is a schematic diagram of a system for real-time media streaming in accordance with an embodiment.

FIG. 2 a schematic block diagram of a user device equipped with an application to enable real-time media streaming in accordance with an embodiment.

FIG. 3 is a flowchart describing the registration to a server of a system for real-time media streaming according to an embodiment.

FIG. 4 is a flowchart describing the authorization to stream content to a real-time content consumer in a system for real-time media streaming according to an embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

According to example embodiments, a server is configured to control access of media content (video, audio, images, data, etc.) streamed from one or more user devices (UDs) to one or more content receivers (CRs). The UDs are registered by the server to be able to stream content to certain of the CRs. Then, when such media content is to be streamed from an authorized UD to the one or more CRs, the server determines eligibility to stream such media content and performs the necessary control functions to enable such transfer. The server may allow, disconnect or disallow any UD attempting to stream media content to anyone of the CRs based on a variety of programmable rules.

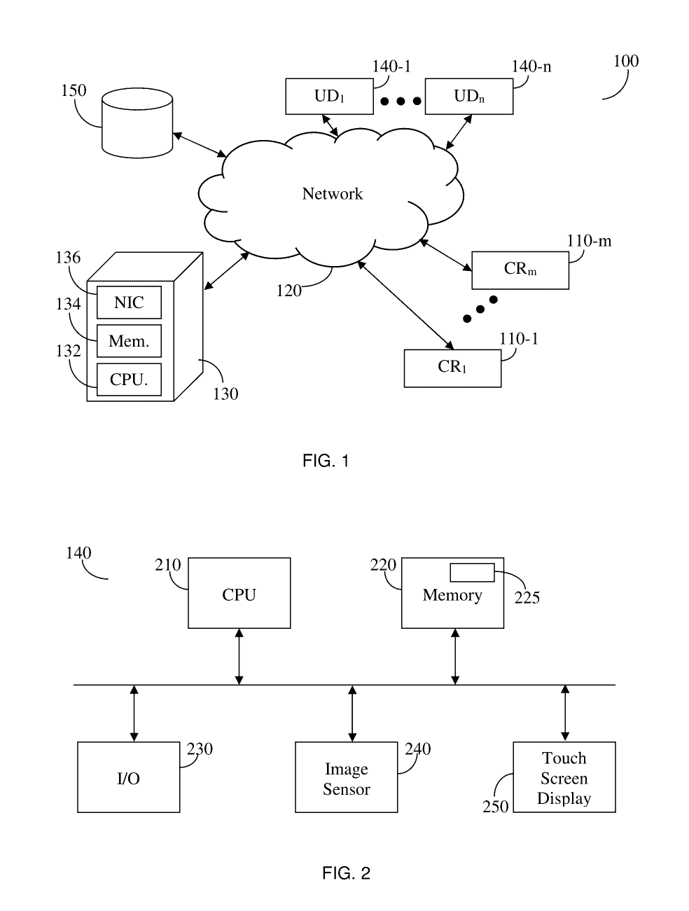

FIG. 1 depicts an example schematic diagram of a system 100 for real-time media (e.g., video) content streaming in accordance with an embodiment. The system 100 comprises a network 120 which allows communication between different elements communicatively connected to the network 120. The network 120 may be a cellular, wired, wireless, local area network (LAN), wide area network (WAN), metro area network (MAN), the Internet and the worldwide web (WWW), and any combination thereof.

One or more UDs 140 are communicatively connected to the network 120, for example UD 140-1 through UD 140-n, where ‘n’ is an integer having a value of ‘1’ or larger. Each UD 140 is a mobile device configured to capture media (e.g., video) content and further configured to stream the captured media content in real-time over the network 120. Also communicatively coupled to the network 120 are one or more CRs 110, for example, CR 110-1 through CR 110-m, where ‘m’ is an integer having a value of ‘1’ or larger.

In an embodiment, the system 100 is made operative by an authorizing server 130 communicatively connected to the network 120. The authorizing server 130 typically comprises a processing element 132, for example a central processing unit, a memory 134 connected to the processing element 132, and a network interface controller (NIC) 136 connected to the processing element 132 and configured to allow network communication to and from the authorizing server 130.

The memory 134 of the authorizing server 130 is at least partially loaded with instructions that when executed by the processing element 132 configures the authorizing server 130 to operate in accordance with the teaching of the invention and as further explained herein. Specifically, the instructions in the memory 134 allow for two basic functions of the system 100, registration of a UD 140, for example UD 140-1 as a registered device that is allowed to send, upon authorization, a real-time content stream from the UD 140-1 to one or more CRs 110, for example to CR 110-1. Once registered, the registration information for the registered UD 140-1 may be stored in the memory 134 or, for example, in a database 150 communicatively connected to the authorizing server 130 via the network 120. This should not be viewed as limiting upon the disclosed embodiment and the database 150 may be directly connected to the authorizing server 130 without departing from the scope of the invention.

The instructions in the memory 134 may further configure the authorizing server to provide to the registered UD 140-1 a link to an application, the application being stored, for example, in the database 150, to be installed on the UD 140-1. The application, further discussed herein, provides the UD 140-1 with the ability to initiate a process for providing real-time media (e.g., video) content captured by the UD 140-1 to a selected CR 110, and as further explained herein.

The memory 134 may also have instructions therein that further configure the authorizing server 130 to respond to a request from the application installed on the UD 140-1 to begin sending a real-time video stream to one or more CRs 110. Upon receiving a request from UD 140-1 to begin sending a real-time media (e.g., video) stream to one or more CRs 110, the server 130 is configured to check whether the UD 140-1 is a registered UD 140, and if so the server 130 may send a real-time media stream to one or more of the CRs 110. Upon validation, notifications are sent to both the accepting CRs 110 and the UD 140-1 to establish the communication link that allows for the transmission of the real-time video content from the UD 140-1 to the accepting CRs 110. This eliminates the overload conditions (of both CRs 110 and the network 120) by allowing a controlled way for providing media content to the one or more CRs 110. In one embodiment the authorizing server 130 is configured by the instructions in memory 134 to first confirm with the targeted CRs 110 for ability to accept the real-time media (e.g., video) stream from the UD 140-1.

FIG. 2 depicts an exemplary and non-limiting schematic block diagram of a UD 140 equipped with an application (225) to enable real-time video content streaming in accordance with an embodiment. A UD 140 may comprise a processing element 210, that may be a central processing unit (CPU) and a memory 220 communicatively connected thereto. To the processing element there are further communicatively connected an input/output (I/O) interface 230 that allows various communication schemes between the UD 140 and other components of the system 100 using the network 120. The UD 140 further comprises, for example, an image sensor 240 for capturing of at least a video stream or any other media.

In an embodiment, the image sensor 240 is operative under the control of the processing element 210 and is communicatively connected thereto. The image sensor 240 is typically communicatively connected also to the memory 220 for permanent or temporary storage of the video stream captured by the image sensor 240. A touch screen display 250 provides both the ability for an image display (i.e., output in the form of an image) as well as the ability to receive one or more inputs responsive to a user touching the touch screen display 250. The touch screen display 250 is communicatively connected to the processing element 210 and the memory 220 for its operation.

The memory 220 of the UD 140 may contain an application 225, comprising a plurality of instructions aimed to be executed by the processing element 210. In addition, the memory 220 may further contain additional instructions, for example in the form of other applications. When the instructions are executed by the processing element 210 they configure the UD 140 to operate in accordance with an embodiment. The application 225 is installed on the UD 140 as described herein, however, other ways of installing such an application 225 are possible without departing from the scope of the disclosed embodiments.

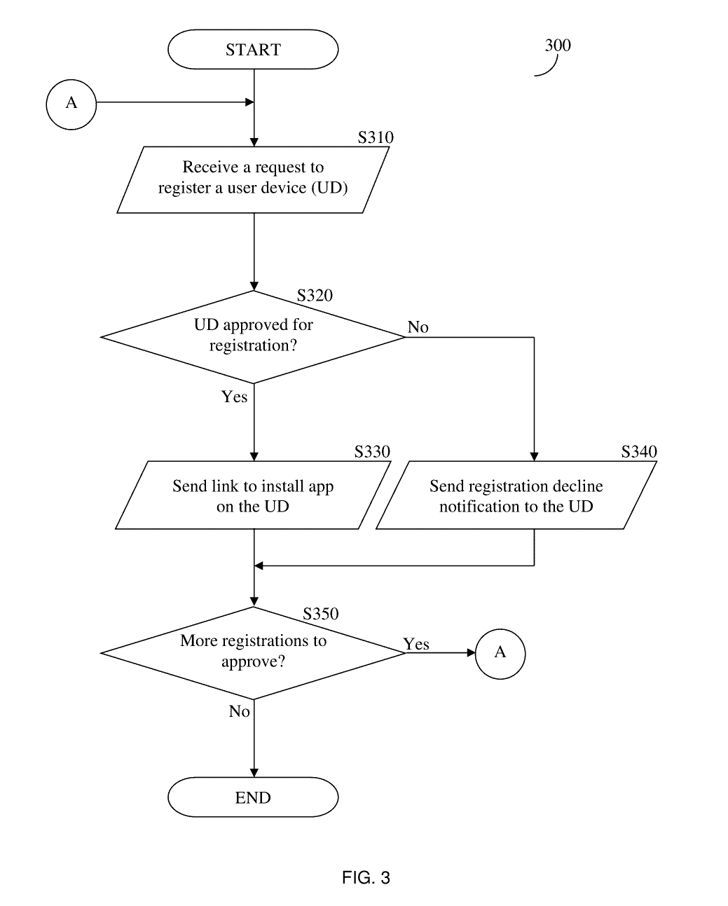

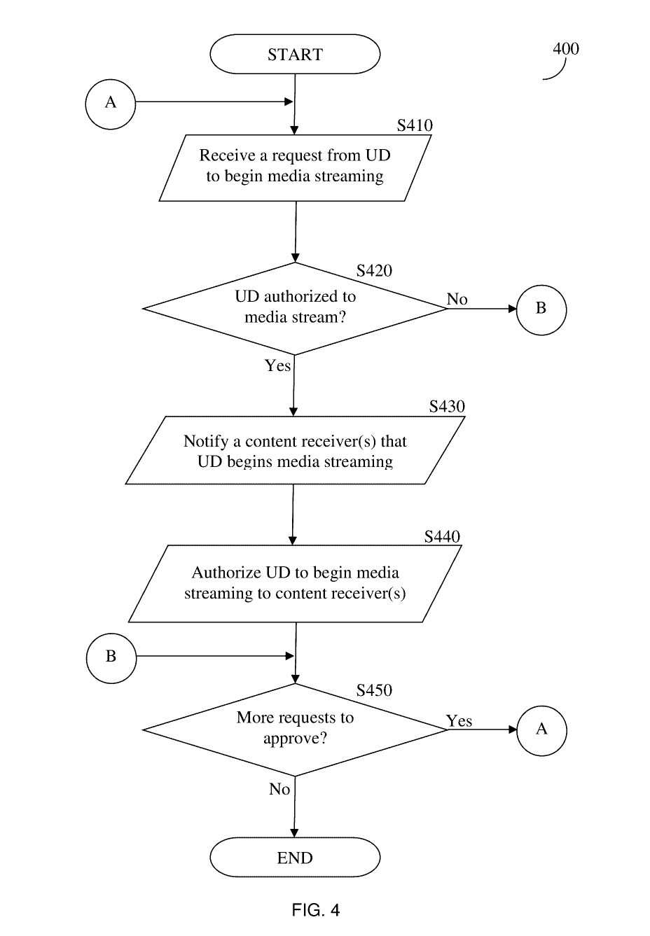

An exemplary installation process is described with respect of FIG. 3. According to one embodiment, the application 225 configures the UD 140 to display on the touch screen display 250 an image of a start button that when touched, causes the UD 140 to request permission to begin a media (e.g., video) streaming transmission as described with respect of FIG. 4. In one embodiment, the start button is displayed as a result of a request from a CR 110 to receive a video stream from UD 140. This may happen if the CR 110 is configured to identify the location of a UD 140, for example, based on GPS information, and requesting to begin a media (e.g., video) stream, for example, for news or police purposes. It should be further understood that in certain embodiments, the media (e.g., video) stream, and/or control communication may be encrypted for the purpose of protection of the integrity of the transmission and its respective content.

FIG. 3 shows an exemplary and non-limiting flowchart 300 describing the registration to a server of a system for real-time video content streaming according to an embodiment. In S310 a request to register a UD 140, for example, UD 140-1 is received by, for example, the server 130. In S320 it is checked whether the UD 140-1 is eligible to be approved for registration. This may require receiving various details about the UD 140-1, the user operating the UD 140-1, checking of other databases, for example the database 150, to ensure the eligibility of the UD 140-1 to be registered, and so on. The eligibility may be also determined based on the CRs 110 to which the UD 140-1 is to provide video streams to. For example, CR 110-1 may be for police purposes and may deny the registration request of UD 140-1 while CR 110-m may be a news station that may agree to have UD 140-1 as a video streaming contributor.

If in S320 the request to register is approved, then execution continues with S330 where an approval notification is sent to the UD 140-1 with, for example, a link to an appropriate application, for example application 225, so that UD 140-1 may install the application 225 on the UD 140-1, and thereafter execution continues with S350. The link to the appropriate application may provide for different approved UD 140 different versions of the application 225. For example, an iPhone® device may require a different version of the application 225 from an Android® based phone. However, if in S320 the request to register is denied, then execution continues with S340 where a denial notification is sent to UD 140-1, after which execution continues with S350.

In S350 it is checked whether additional registrations are to be handled and if so, execution continues with S310; otherwise, execution terminates.

FIG. 4 depicts an exemplary and non-limiting flowchart 400 describing the authorization to stream media (e.g., video) content to a real-time media CR 110 in a system 100 for real-time media (e.g., video) content streaming according to an embodiment. Specifically, the flowchart 400 describes the operation according to an embodiment after the initial installation of the application 225 on the UD 140, for example, UD 140-1.

In S410, a request to begin media (e.g., video) streaming is received by the authorizing server 130 from the UD 140-1, now configured with the proper application 225, and as described herein. It should be understood that while the description here begins with the user of the UD 140-1 initiating a request to begin media (e.g., video) streaming, in another embodiment the request to begin such media (e.g., video) streaming is initiated in response to a request from a CR 110, for example CR 110-1, to the UD 140-1 to begin media (e.g., video) streaming. Such a request may be received as a result of identification of the location of the UD 140-1 at a point where it is desirable to receive therefrom a media (e.g., video) stream.

In S420, it is checked whether the UD 140-1 is authorized to send a video stream to one or more CRs 110, and if so, execution continues with S430; otherwise, execution continues with S450. The check performed in S420 may cause the authorizing server 130 to check information in a database, for example, the database 150, to ensure that the UD 140-1 is actually authorized to send such a media (e.g., video) stream. Such authorization may be, in an embodiment, adaptive, that is, at certain times such a transmission would be allowed while not in other times. For example, as more UDs 140 provide a media (e.g., video) stream from the same location, it may be desirable for a CR 140, for example CR 140-1, to cease connection with a UD 140 capturing an event from a less desirable angle, at a lower image quality, etc. and thereby free up bandwidth for other media (e.g., video) streams.

Therefore, it should be understood that an initial authorization to transmit a media (e.g., video) stream from a UD 140 to a CR 110 does not mean that this authorization will continue and vice versa, an initial decline may not mean that a subsequent request to provide a media (e.g., video) stream would also be declined. Such embodiments provide for a flexible solution that maintains reasonable, efficient and controlled use of the available bandwidth.

Once a UD 140-1 is approved to provide a media (e.g., video) stream to one or more CRs 110, the one or more CRs 110 are notified, in S430, that they are expect to receive such content. In one embodiment, a communication link is to be established between the UD 140-1 and a CR 110 for efficient media (e.g., video) streaming. In S440, the UD 140-1 is authorized to begin the media (e.g., video) streaming to at least one of the CRs 110. In S450 it is checked whether more requests are to be checked and if so execution continues with S410; otherwise, execution terminates.

As an example for the disclosed embodiment is a news broadcasting station that wishes to allow qualified users of mobile devices to provide it with real-time media (e.g., video) content. Such a potential user must first go through an initial registration process and as a result receive a link to an application for the specific mobile device being registered that the user must upload to the registered mobile device. Then, upon determination by the user of the mobile device that there is an event that the user wishes to stream in real-time to the news broadcasting station, a request is sent to the authorizing server, by using the user interface provided by the installed application. Upon authorization by the authorizing server, a communication link between the mobile device and the appropriate content receiver, for example a server, is opened and a stream of media (e.g., video) may flow to the news broadcasting station.

There, the director can decide what portions of the media stream to actually broadcast in real-time. In one embodiment an agreement between the user of the mobile device and the broadcasting station may include compensations in various forms, including, but not limited to, one-time payment, royalties, and the like.

In another embodiment, the broadcasting station may instruct the authorizing server to either temporarily or permanently disallow the transmission of real-time media (e.g., video) streaming from a particular user device to the broadcasting station. This can happen because of problems with the provider of the media (e.g., video) content or, for example, due to an overload on the station where multiple authorized mobile devices attempt real-time media (e.g., video) streaming to the broadcasting station. In yet another embodiment, the broadcasting station may prefer to receive media (e.g., video) content from a particular location from one or more preferred source and can configure the authorizing server to do so. One of ordinary skill in the art would readily appreciate that the described system may be configured for a police use enabling citizen confirmed by the police to provide reports in real-time by streaming real-time video content.

In yet another example of the disclosed invention a CR, for example CR₁ 110-1, is configured to receive media (e.g., video) streams from a plurality of UDs 140. CR₁ 110-1 may be configured to identify the location of the plurality of UDs 140 and select therefrom one or more of the plurality of UDs 140 to stream video to CR₁ 110-1. In one embodiment, the selection can be further done based on the specific angle or content being transmitted by each of the UDs 140 so as to enable to provide a full coverage of a scene at a particular location, for example, but without limitations, a 360° view of a location. For instance, an event may take place in Central Park, New York, N.Y., and multiple UDs 140 are present. Some may be capturing the event, others simply present. The CR₁ 110-1 may be configured to determine which of the plurality of UDs 140 may be used for streaming media (e.g., video) content to CR₁ 110-1. It may further determine which of the plurality of UDs 140 should not be providing media (e.g., video) streams, for a variety of reasons. These reasons may include, but are not limited to, poor quality of picture, not the content desired for the CR₁ 110-1, repeat content already provided by another one of the plurality of UDs 140, etc. Moreover, when certain registered UDs from the plurality of UDs 140 are present at the location but are not providing a media (e.g., video) stream, the CR₁ 110-1 may provide instructions to such UDs to start transmission of a media (e.g., video) stream to the CR₁ 110-1. It may further provide specific instructions as to a desired angle and physical position from which the CR₁ 110-1 desires such content to be provided from. As a result, an event occurring, for example in Central Park, New York, N.Y., may be fully covered by a desired number of UDs from the plurality of UDs 140, without overloading the bandwidth available to the CR₁ 110-1 at any given point in time.

In a further application, for example and not by way of limitation, UDs 140 may be instructed to communicate with a particular CR, for example CR₁ 110-1. For instance, if the event in Central Park, New York, N.Y. is an event that is of a police concern, then the CR 110 may be configured so as to ensure that communication is provided to a police station responsible of monitoring events in that location, rather than in a CR 110 responsible for monitoring Central Park, Santa Clara, Calif., which may be monitored by a different CR 110 and a different set from the plurality of UDs 140 will be able to transmit from events occurring there. Accordingly, while a selection of a particular CR 110 to be connected to may be done by any individual UD, it is also possible for any particular CR 110 to select one or more UDs 140 in a particular location to provide video streams to the particular CR 110. Moreover, if the scene is not static, for example, a hijacked car that happened to begin at Central Park, New York, N.Y., it may be tracked by using a plurality of UDs 140 as the car makes its way south on, for example, 5^{th} avenue, allowing for UDs 140, that may be on that path to provide a video stream, disconnecting such UDs that provided a media (e.g., video) stream from the corner of 5^{th} avenue and Central Park South, when the vehicle reaches, for example, 5^{th} avenue and 57^{th} street. This allows saving of bandwidth available to a particular CR 110 for those media (e.g., video) streams that are of specific interest in a particular event.

The various embodiments may be implemented as hardware, firmware, software, or any combination thereof. Moreover, the software is preferably implemented as an application program tangibly embodied on a program storage unit or tangible computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal.

All examples and conditional language recited herein are intended for pedagogical purposes to aid the reader in understanding the principles and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for controlled streaming of real-time media content, comprising:
receiving a request for a user device to stream the real-time media content to an at least one content receiver;
determining, by an authorization server, whether the user device is authorized to send the real-time media content to at least one of the at least one content receiver;
notifying, by the authorization server, the at least one of the at least one content receiver to accept the real-time media content from the user device responsive of affirmative determination made by the authorization server to permit the streaming of the media content to the at least one of the at least one content receiver; and
notifying, by the authorization server, the user device to begin real-time media content streaming to the at least one of the at least one content receiver responsive of affirmative determination made by the authorization server to permit the streaming of the real-time media content to the at least one of the at least one content receiver.

2. The method of claim 1, further comprising:
receiving by the authorization server a request to authorize the user device to stream the real-time media content to the at least one of the at least one content receiver;
checking at least a database for determination of eligibility to stream the real-time media content to the at least one of the at least one content receiver; and
updating the at least a database with authorization information respective of the user device for the at least one of the at least one content receiver.

3. The method of claim 2, further comprising:
providing a link to the user device for downloading an application to the user device, the application configured to enable a user of the user device to send the request to the authorization server.

4. The method of claim 1, further comprising:
determining periodically whether the user device continues to be authorized to stream the real-time media content to the at least one of the at least one content receiver; and,
responsive of the determination causing one of: allowing continuation of the stream of the real-time media by the user device, or, denying continuation of the stream of the real-time media by the user device.

5. The method of claim 4, wherein the periodic determination is made based on at least one of: location from which the real-time media content is streamed, quality of the streamed real-time media content, angle of video capture of the streamed media content, a parameter provided by the at least one of the at least one content receiver, other user devices providing real-time media content to the at least one of the at least one content receiver, or bandwidth requirements.

6. The method of claim 1, wherein the media content comprises at least one of: video, audio, image, data, and combination thereof.

7. A non-transitory computer readable medium having stored thereon instructions for causing one or more processing elements to execute the method according to claim 1.

8. A system for controlled streaming of real-time video content, comprising:
a network interface configured to communicatively connect to the at least a user device and to at least a content receiver, the user device is configured to stream in real-time media content captured by the user device;
a processing element connected to the network interface; and
a memory connected to the processing element, the memory containing instructions that when executed by the processing element, configure the system to:
receive a request for a user device to stream the real-time media content to an at least one content receiver;
determine whether the user device is authorized to send the real-time media content to at least one of the at least one content receiver;
notify the at least one of the at least one content receiver to accept the real-time media content from the user device responsive of affirmative determination to permit the streaming of the media content to the at least one of the at least one content receiver; and
notify the user device to begin real-time media content streaming to the at least one of the at least one content receiver responsive of affirmative determination made by the authorization server to permit the streaming of the real-time media content to the at least one of the at least one content receiver.

9. The system of claim 8, the system is further configured to:
receive a request to authorize the user device to stream the real-time media content to the at least one of the at least one content receiver;
check at least a database communicatively connected to the system for determination of eligibility to stream the real-time media content to the at least one of the at least one content receiver; and
update the at least a database with authorization information respective of the user device for the at least one of the at least one content receiver.

10. The system of claim 9, the system is further configured to:
provide a link to the user device for downloading an application to the user device, the application configured to enable a user of the user device to send the request to the authorization server.

11. The system of claim 8, the system is further configured to:
determine periodically whether the user device continues to be authorized to stream the real-time media content to the at least one of the at least one content receiver; and,
responsive of the determination causing one of: allow continuation of the stream of the real-time media by the user device, or, deny continuation of the stream of the real-time media by the user device.

12. The system of claim 11, wherein the periodic determination is made based on at least one of: location from which the real-time media content is streamed, quality of the streamed real-time media content, angle of video capture of the streamed media content, a parameter provided by the at least one of the at least one content receiver, other user devices providing real-time media content to the at least one of the at least one content receiver, or bandwidth requirements.

13. The system of claim 8, wherein the media content comprises at least one of: video, audio, image, or data.

14. A mobile device for controlled streaming of real-time media content, comprising:
a network interface configured to enable at least data communication to and from the mobile device;
a processing element connected to the network interface;
an image capturing device connected to the processing element and configured to capture of a real-time media stream; and
a memory connected to the processing element, the memory containing instructions that when executed by the processing element, configure the mobile device to:
request authorization to provide a real-time video stream from the user device to at least a content receiver, the at least content receiver communicatively connected to the network;
receive an authorization to stream to the at least a content receiver communicatively coupled to the network from the authorization server; and
stream the real-time video stream to the at least content receiver.

15. The mobile device of claim 14, wherein the media content comprises at least one of: video, audio, image, or data.

16. The mobile device of claim 14, the mobile device is further configured to:
receive from the authorization server instructions to: begin streaming real-time media content to the at least a content receiver; continue streaming real-time media content to the at least a content receiver; or, discontinue streaming of the real-time media content to the at least a content receiver.

17. The mobile device of claim 14, the mobile device is further configured to:
receive from the authentication server instructions to a user of the user device to position the user device in at least one of: a desired location; a desired angle of capture.

18. The mobile device of claim 17, wherein the instructions are displayed on a display of the user device.
